(19) United States
(12) Patent Application Publication
(10) Pub. No.: US 2021/0149392 A1
(43) Pub. Date: May 20, 2021

(54) VEHICLE, REMOTE IMAGING-AND-CONTROLLING SYSTEM, METHOD FOR CONTROLLING VEHICLE, AND NON-TRANSITORY RECORDING MEDIUM

(71) Applicant: SHARP KABUSHIKI KAISHA, Sakai City (JP)

(72) Inventor: SHOICHI SHITARA, Sakai City (JP)

(21) Appl. No.: 17/095,341

(22) Filed: Nov. 11, 2020

(30) Foreign Application Priority Data
Nov. 14, 2019 (JP) 2019-206185

(51) Int. Cl. G05D 1/00; H04N 19/115; H04N 19/139; H04N 19/172

(52) U.S. Cl. CPC G05D 1/0033; H04N 19/172; H04N 19/139; H04N 19/115

(57) ABSTRACT

A vehicle comprises a command obtainer configured to obtain information indicating a command of a user and determining a motion of the vehicle, a driver configured to move the vehicle in accordance with the information determining the motion, an imager configured to capture a video around the vehicle, an encoder configured to encode the video captured by the imager, a motion state identifier configured to identify a motion state of the vehicle, a video controller configured to control, depending on the motion state, at least one of (i) a resolution of the video to be captured by the imager, (ii) a frame rate of the video to be captured by the imager, (iii) a resolution of the video to be encoded by the encoder and (iv) a bit rate of the video encoded by the encoder, and an output unit configured to output the video encoded by the encoder.

### CROSS-REFERENCE TO RELATED APPLICATION

The present application claims priority from Japanese Application JP2019-206185, the content of which is hereby incorporated by reference into this application.

### BACKGROUND OF THE INVENTION

### 1. Field of the Invention

The present invention relates to a vehicle, a remote imaging-and-controlling system, a method for controlling the vehicle, and a non-transitory recording medium.

### 2. Description of the Related Art

A typical technique known in the art allows an operator to remotely control a vehicle equipped with a camera through a wireless network.

Japanese Unexamined Patent Application Publication No. 2011-028495 discloses a remote controller. To overcome delay in transmission of a video captured by a camera, the remote-control device corrects the transmission delay of the video at a video recipient using information from another sensor, and displays the corrected video. Hence, the remote controller alleviates effects on the remote control.

### SUMMARY OF THE INVENTION

A next generation wireless communications technology; namely, 5G, provides sufficient data traffic to transmit, for example, an ultra-high-resolution video referred to as an 8K video with very little transmission delay. Meanwhile, transmitting an ultra-high-resolution video takes longer time in video processing (hereinafter also referred to as encoding) than transmitting, for example, a low-resolution video referred to as a 2K video. Hence, encoding the ultra-high-resolution video causes a delay. Thus, when a vehicle, capturing an ultra-high-resolution video with a camera and transmitting the captured video, is remotely controlled, the problem is that the encoding delay affects the remote control.

An aspect of the present invention is intended to reduce processing delay of a video to be transmitted from a vehicle.

In order to overcome the above problems, a vehicle according to an aspect of the present invention includes: a command obtainer obtaining information indicating a command of a user and determining a motion of the vehicle; a driver moving the vehicle in accordance with the information determining the motion; an imager capturing a video around the vehicle; an encoder encoding the video captured by the imager; a motion state identifier identifying a motion state of the vehicle; a video controller controlling, depending on the motion state, at least one of: (i) a resolution of the video to be captured by the imager; (ii) a frame rate of the video to be captured by the imager; (iii) a resolution of the video to be encoded by the encoder; and (iv) a bit rate of the video encoded by the encoder; and an output unit outputting the video encoded by the encoder.

In order to overcome the above problems, a remote imaging-and-controlling system including a vehicle and a controller according to an aspect of the present invention includes: a command obtainer obtaining, from the controller, information indicating a command of a user and determining a motion of the vehicle; a driver moving the vehicle in accordance with the information determining the motion; an imager capturing a video around the vehicle; an encoder encoding the video captured by the imager; a motion state identifier identifying a motion state of the vehicle; a video controller controlling, depending on the motion state, at least one of: (i) a resolution of the video to be captured by the imager; (ii) a frame rate of the video to be captured by the imager; (iii) a resolution of the video to be encoded by the encoder; and (iv) a bit rate of the video encoded by the encoder; and a first output unit outputting, to the controller, the video encoded by the encoder. The controller includes: a video obtainer obtaining the encoded video from the vehicle; a decoder decoding the encoded video; a display displaying the video decoded by the decoder; an operation obtainer obtaining the information indicating the command of the user and determining the motion of the vehicle; and a second output unit outputting, to the vehicle, the information obtained by the operation obtainer.

In order to overcome the above problems, a remote imaging-and-controlling system according to an aspect of the present invention includes: a vehicle; and a controller. The vehicle includes: a command obtainer obtaining, from the controller, information indicating a command of a user and determining a motion of the vehicle; a driver moving the vehicle in accordance with the information determining the motion; an imager capturing a video around the vehicle; an encoder encoding the video captured by the imager; a motion state identifier identifying a motion state of the vehicle; a video controller controlling, depending on the motion state, at least one of: (i) a resolution of the video to be captured by the imager; (ii) a frame rate of the video to be captured by the imager; (iii) a resolution of the video to be encoded by the encoder; and (iv) a bit rate of the video encoded by the encoder; and a first output unit outputting, to the controller, the video encoded by the encoder. The controller includes: a video obtainer obtaining the encoded video from the vehicle; a decoder decoding the encoded video; a display displaying the video decoded by the decoder; an operation obtainer obtaining the information indicating the command of the user and determining the motion of the vehicle; and a second output unit outputting, to the vehicle, the information obtained by the operation obtainer.

In order to solve the above problems, a method for controlling a vehicle includes: obtaining information indicating a command of a user and determining a motion of the vehicle; moving the vehicle in accordance with the information determining the motion; capturing a video around the vehicle; encoding the video captured in the capturing; identifying a motion state of the vehicle; (i) a resolution of the video to be captured in the capturing; (ii) a frame rate of the video to be captured in the capturing; (iii) a resolution of the video to be encoded in the encoding; and (iv) a bit rate of the video encoded in the encoding; and outputting the video encoded in the encoding.

An aspect of the present invention makes it possible to reduce processing delay of a video to be transmitted from a vehicle.

### BRIEF DESCRIPTION OF THE DRAWINGS

FIG. 1 is a functional block diagram of a remote imaging-and-controlling system according to a first embodiment of the present invention;

FIG. 2 is an overall view according to the first embodiment of the present invention;

FIG. 3 is an illustration of a cropped region according to the first to third embodiments of the present invention;

FIG. 4 is a flowchart according to the first embodiment of the present invention;

FIG. 5 is a functional block diagram of a remote imaging-and-controlling system according to the second embodiment of the present invention;

FIG. 6 is a flowchart according to the second embodiment of the present invention;

FIG. 7 is a functional block diagram of a remote imaging-and-controlling system according to the third embodiment of the present invention; and

FIG. 8 is a flowchart according to the third embodiment of the present invention.

### DETAILED DESCRIPTION OF THE INVENTION

### First Embodiment

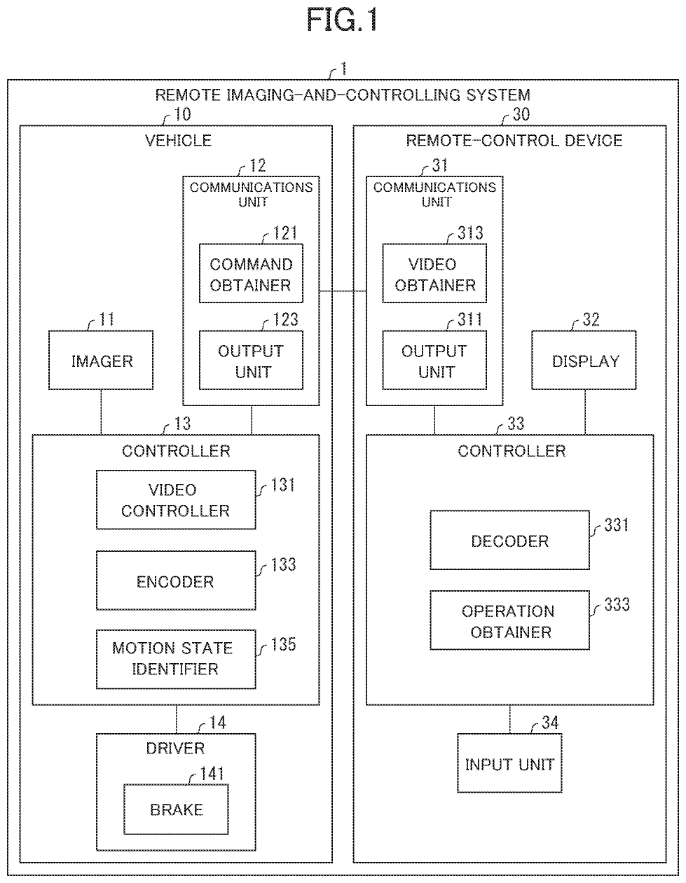

Described below in detail is an embodiment of the present invention. FIG. 1 is a functional block diagram of a remote imaging-and-controlling system according to a first embodiment of the present invention.

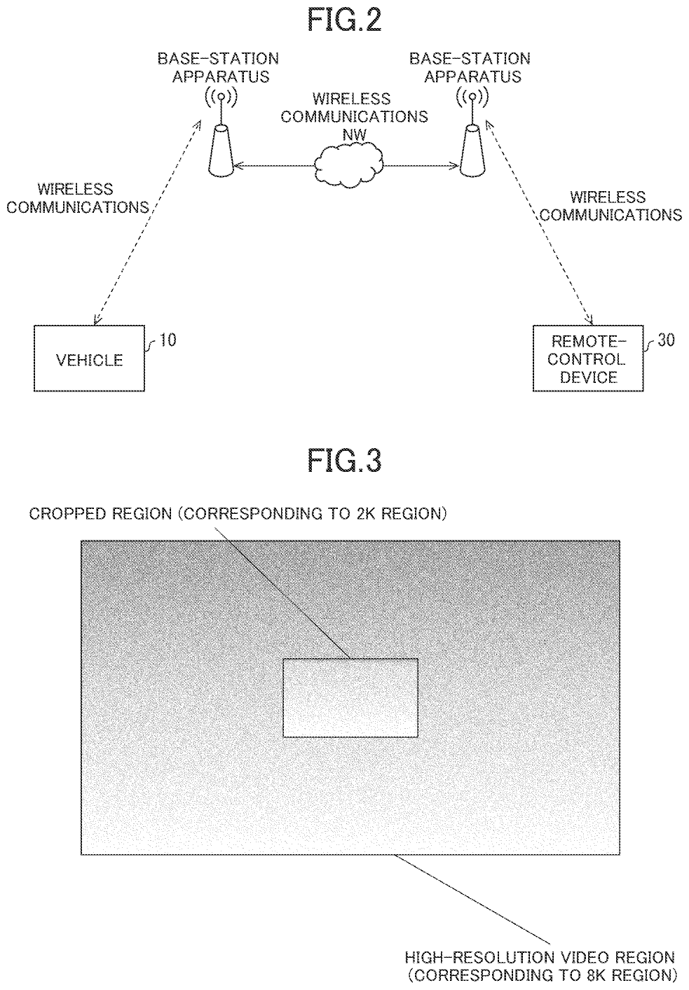

As illustrated in FIG. 1, a remote imaging-and-controlling system 1 includes: a vehicle 10; and a remote-control device (a control device) 30. FIG. 2 is an overall view according to the first embodiment of the present invention. As illustrated in FIG. 2, the remote-control device 30 communicates with the vehicle 10 through a base-station apparatus. When operating the vehicle 10, the communications may be established wirelessly or by wire between the vehicle 10 and the base-station apparatus and between the base-station apparatus and the remote-control device 30. FIG. 2 shows that the vehicle 10 and the remote-control device 30 directly communicate with each other through wireless communications.

Vehicle 10

The vehicle 10 is operated on the remote-control device 30 to move. The vehicle 10 is powered by electricity or fossil fuel. The vehicle 10 includes: an imager 11; a communications unit 12; a controller 13; and a driver 14.

The imager 11 captures a video around the vehicle 10. The imager 11 can capture an ultra-high-resolution video, and can also capture a low-resolution video by setting a cropped region to be described later. Moreover, one imager 11, or two or more imagers 11 may be mounted on the vehicle 10. Furthermore, the imager 11 of the vehicle 10 may be secured anywhere on the vehicle 10. The video captured by the imager 11 is transmitted to the remote-control device 30 through the controller 13 and the communications unit 12 to be described later. Furthermore, the video captured by the imager 11 is usually a moving image sequence.

The communications unit 12 transmits information from the controller 13 to the remote-control device 30, and receives information transmitted from the remote-control device 30. The communications unit 12 includes: a command obtainer 121; and an output unit (a first output unit) 123. The command obtainer 121 obtains from the remote-control device 30 information indicating a command of a user operating the remote-control device 30 and determining a motion of the vehicle 10. The information includes information on whether the imager 11 continues to capture the video. Moreover, the information includes information on a direction and a speed of the vehicle 10 in motion. The output unit 123 transmits the information, output from the controller 13, to the remote-control device 30. The information obtained from the controller 13 includes the video captured by the imager 11. Furthermore, the information may separately include information on a driving state of the driver 14. For example, the separate information may be referred to when the remote-control device 30 displays the speed of the vehicle 10. The video captured by the imager 11 may be of an ultra-high resolution or a low resolution, or of a high frame rate or a low frame rate. The information on the driving state of the driver 14 includes information on a signal to drive the driver 14 and information on an operating state of a brake 141, the details of which will be described later.

The controller 13 controls the imager 11, the communications unit 12, and the driver 14 all of which are included in the vehicle 10. The controller 13 includes: a video controller 131; an encoder 133; and a motion state identifier 135.

Depending on a motion state of the vehicle 10, the video controller 131 controls at least one of: (i) a resolution of a video to be captured by the imager 11, (ii) a frame rate of the video to be captured by the imager 11, (iii) a resolution of the video to be encoded by the encoder 133, and (iv) a bit rate of the video encoded by the encoder 133. As to the resolution of the video captured by the imager 11, the video appears sharper as the resolution of the video is higher, and the video appears more blurry as the resolution of the video is lower. The frame rate of the video to be captured by the imager 11 is the number of images captured per unit of time. More images are captured per unit of time as the frame rate is higher, and fewer images are captured per unit of time as the frame rate is lower. The resolution of the video to be encoded is the same as that of the video to be captured by the above imager 11. The bit rate of the encoded video is an amount of video data per second. The amount of data to be transmitted is larger with a higher bit rate, and the amount of data to be transmitted is smaller with a lower bit rate.

The encoder 133 encodes the video captured by the imager 11. In accordance with the video resolution or the video bit rate determined by the video controller 131, the encoder 133 encodes the video captured by the imager 11. The encoding involves encoding data of the video.

The motion state identifier 135 identifies a motion state of the vehicle 10. The identified motion state of the vehicle 10 is output to the communications unit 12. The motion state of the vehicle 10 is identified from the information on the signal transmitted to the driver 14 or on an operating state of the brake 141.

The driver 14 drives and moves the vehicle 10. The signal (hereinafter referred to as a drive signal) to drive the driver 14 is transmitted from the controller 13. A driving state of the driver 14 is identified by the motion state identifier 135, using the drive signal. Furthermore, the driver 14 includes the brake 141. The operating state of the brake 141 is identified by the motion state identifier 135. The driver 14 may be an internal combustion engine including such a rotating unit as a wheel, or may be a propulsion engine including such a rotating unit as a conveyor belt.

Remote-Control Device 30

The vehicle 30 is to operate the remote-control device 10. The remote-control device 30 may be stationary or mobile inside or outside of the room. The remote-control device 30 is powered by electricity. The remote-control device 30 includes: a communications unit 31; a display 32; a controller 33; and an input unit 34.

The communications unit 31 transmits information from the controller 33 to the vehicle 10, and receives information transmitted from the vehicle 10. The communications unit 31 includes: an output unit (a second output unit) 311; and a video obtainer 313. The output unit 311 transmits the information, obtained from the controller 33, to the vehicle 10. The information obtained from the controller 33 includes information indicating a command of the user operating the above remote-control device 30, and determining a motion of the vehicle 10. The video obtainer 313 obtains the video transmitted from the communications unit 12. The communications unit 31 outputs the received information to the controller 33 to be described later.

The display 32 displays the video processed by the controller 33 so that the user can check the processed video. The controller 33 will be described later. The display 32 can present visual information. Examples of the display 32 may include various displays such as a liquid-crystal display, a plasma display, an organic EL display. The display 32 may include, but not limited to, a single screen. Alternately, the display 32 may include two or more screens.

The controller 33 controls the remote-control device 30. The controller 33 includes: a decoder 331; and an operation obtainer 333. The decoder 331 decodes the information received from the output unit 311, and outputs the decoded information to the display 32. The decoding involves decoding the encoded video data. The operation obtainer 333 obtains from the input unit 34 information on an operation of the vehicle 10. The input unit 34 will be described later. The information on the operation of the vehicle 10 is a group of commands to operate constituent features included in the vehicle 10. For example, this group of commands includes: a command to specify what the imager 11 captures; a command to cause the imager 11 to focus; a command on driving of the driver 14; and a command to apply and release the brake 141.

The input unit 34 is operated by the user to input a command through the remote-control device 30 to the vehicle 10. The input unit 34 includes a program in which a plurality of commands are combined together. The commands to the input unit 34 may be entered by character input, by audio input, with a joy stick, or with a steering wheel.

Cropped Region

Cropping involves cutting out a part of a video (e.g., a center of a video) to be captured. FIG. 3 is an illustration of a cropped region according to the first to third embodiments of the present invention. As illustrated in FIG. 3, the cropped region is usually a cut-out center of a video to be captured. The video controller 131 can replace the video to be obtained by the imager 11 with a low-resolution video in the cropped region. Such processing reduces load on encoding, and thus reduces a delay in the encoder 133. A cropping mode involves cropping a part of the whole video obtained by the imager 11, and outputting a low-resolution video.

Process

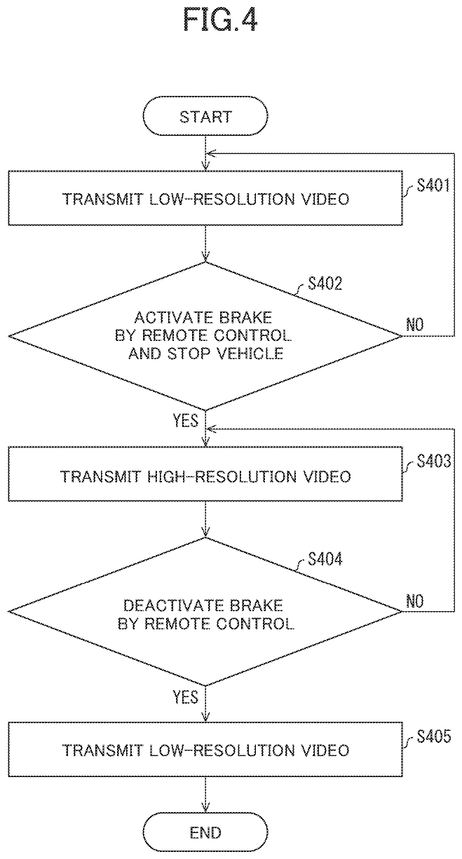

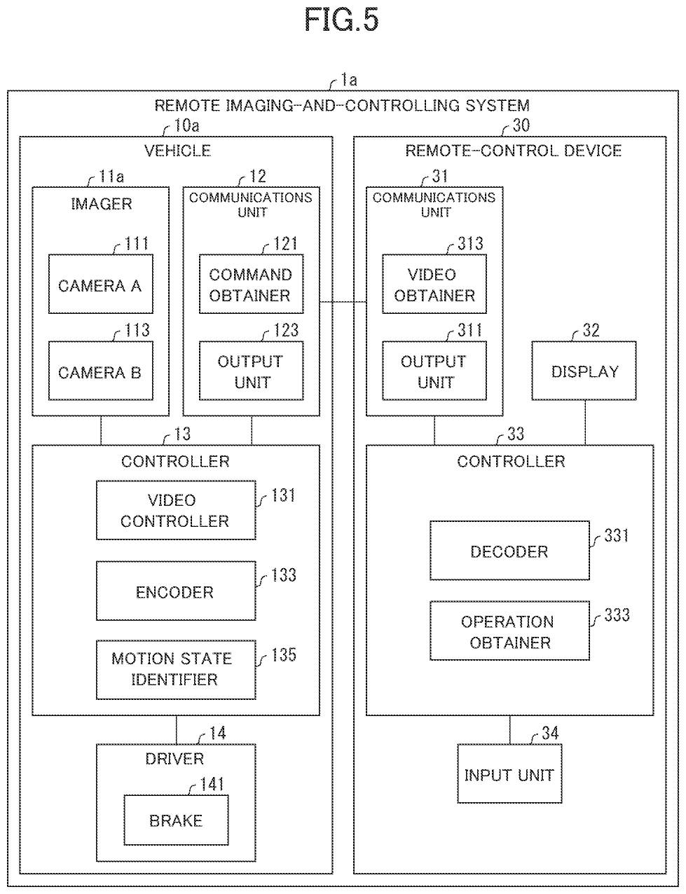

FIG. 4 is a flowchart according to the first embodiment of the present invention. The flowchart in FIG. 4 shows a process in which the vehicle 10 captures: a low-resolution video while the vehicle 10 is moving; and a high-resolution video while the vehicle 10 is in a halt. The flowchart in FIG. 4 starts when the vehicle 10 starts to move and capture a video. Moreover, from Steps S401 to S405 to be described later, a command for applying the brake 141 is a signal to the driver 14. Instead of the command to apply the brake 141, the motion state identifier 135 may refer to a control signal to be supplied to the driver 14 to identify the motion state of the vehicle 10.

Step S401

At Step S401, the vehicle 10 is moving. When the imager 11 captures a video, the video controller 131 replaces the captured video with a low-resolution video, and the vehicle 10 transmits the low-resolution video to the remote-control device 30. The display 32 displays the transmitted low-resolution video.

Step S402

At Step S402, the controller 13 determines whether the command obtainer 121 has received a command for applying the brake 141. The command is information to be transmitted from the remote-control device 30 to the vehicle 10 when the user sends an instruction through the input unit 34 to activate the brake 141 of the vehicle 10. If the command obtainer 121 has received the transmitted command (Step S402: YES), the controller 13 activates the brake 141. The process proceeds to Step S403. If the command obtainer 121 has not received the command (Step S402: NO), the process returns to Step S401. When the imager 11 captures a video, the video controller 131 replaces the captured video with a low-resolution video. The vehicle 10 transmits the low-resolution video to the remote-control device 30. The display 32 displays the transmitted low-resolution video.

Step S403

At Step S403, a high-resolution video captured by the imager 11 is transmitted as it is by the video controller 131 to the remote-control device 30. The display 32 displays the transmitted high-resolution video, and the process proceeds to Step S404.

Step S404

At Step S404, the controller 13 determines whether the command obtainer 121 has received a command for deactivating the brake 141 and for moving the vehicle 10. If the command obtainer 121 has received the transmitted command (Step S404: YES), the controller 13 deactivates the brake 141, and drives the driver 14. The process proceeds to Step S405. If the command obtainer 121 has not received the transmitted command (Step S404: NO), the process returns to Step S403. When the imager 11 captures a high-resolution video, the video controller 131 leaves the captured video as it is. The vehicle 10 transmits the high-resolution video to the remote-control device 30. The display 32 displays the transmitted high-resolution video.

Step S405

At Step S405, the vehicle 10 is moving. When the imager 11 captures a video, the video controller 131 replaces the captured video with a low-resolution video, and the vehicle 10 transmits the low-resolution video to the remote-control device 30. The display 32 displays the transmitted low-resolution video.

### Advantageous Effects

The first embodiment makes it possible to output a video having a resolution or a bit rate based on a moving speed of the vehicle.

### Second Embodiment

Described below is another embodiment of the present invention. Note that, for the sake of description, constituent features having the same function between the first embodiment and this embodiment are denoted with the same reference sign. Such constituent features will not be repeatedly elaborated upon.

FIG. 5 is a functional block diagram of a remote imaging-and-controlling system according to the second embodiment of the present invention. As illustrated in FIG. 5, a remote imaging-and-controlling system 1a includes: a vehicle 10a; and the remote-control device 30. Other than an imager 11a, the vehicle 10a is the same in configuration as the vehicle 10 of the first embodiment. The remote-control device 30 is the same in configuration as that of the first embodiment.

Imager 11a

The imager 11a includes: a camera A111; and a camera B113. The camera A111 is capable of capturing a low-resolution video. The camera B113 is capable of capturing a high-resolution video. As another aspect of this embodiment, the camera A111 may be capable of capturing a video having a low frame rate, and the camera B113 may be capable of capturing a video having a high frame rate.

Process

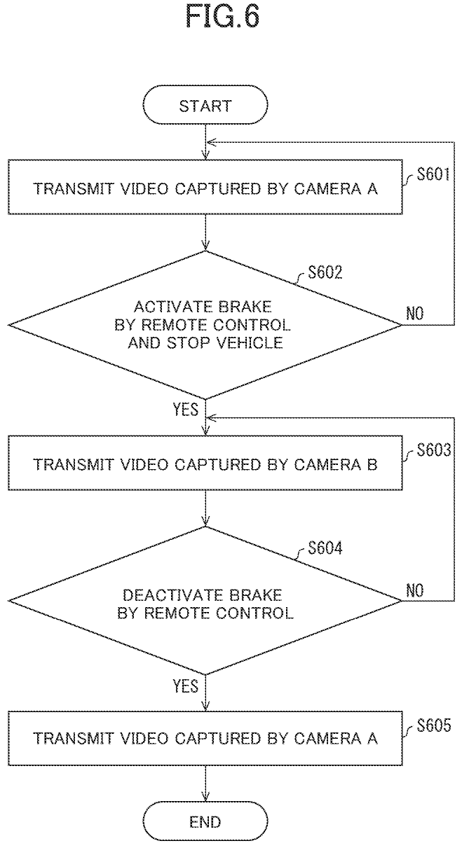

FIG. 6 is a flowchart according to the second embodiment of the present invention. The flowchart in FIG. 6 shows a process in which the vehicle 10a captures: a video with the camera A111 while the vehicle 10a is moving; and a video with the camera B113 while the vehicle 10 is in a halt. The flowchart in FIG. 6 starts when the vehicle 10a starts to move and the camera A111 starts to capture a video. Moreover, from Steps S601 to S605 to be described later, the command for applying the brake 141 is a signal to the driver 14. Instead of the command to apply the brake 141, the motion state identifier 135 may refer to a control signal to be supplied to the driver 14 to identify the motion state of the vehicle 10a.

Step S601

At Step S601, the vehicle 10a is moving. When the camera A111 captures a video, the vehicle 10a transmits the captured video to the remote-control device 30. The display 32 displays the transmitted video.

Step S602

At Step S602, the controller 13 determines whether the command obtainer 121 has received a command for applying the brake 141. The command is information to be transmitted from the remote-control device 30 to the vehicle 10a when the user sends an instruction through the input unit 34 to activate the brake 141 of the vehicle 10a. If the command obtainer 121 has received the transmitted command (Step S602: YES), the controller 13 activates the brake 141. The process proceeds to Step S603. If the command obtainer 121 has not received the command (Step S602: NO), the process returns to Step S601. When the camera A111 captures a video, the vehicle 10a transmits the captured video to the remote-control device 30. The display 32 displays the transmitted video.

Step S603

At Step S603, when the camera B113 captures a video, the vehicle 10a transmits the captured video to the remote-control device 30. The display 32 displays the transmitted video, and the process proceeds to Step S604.

Step S604

At Step S604, the controller 13 determines whether the command obtainer 121 has received a command for deactivating the brake 141 and for moving the vehicle 10a. If the command obtainer 121 has received the transmitted command (Step S604: YES), the controller 13 deactivates the brake 141, and drives the driver 14. The process proceeds to Step S605. If the command obtainer 121 has not received the transmitted command (Step S604: NO), the process returns to Step S603. When the camera B113 captures a video, the vehicle 10a transmits the captured video to the remote-control device 30. The display 32 displays the transmitted video.

Step S605

At Step S605, the vehicle 10a is moving. When the camera A111 captures a video, the vehicle 10a transmits the captured video to the remote-control device 30. The display 32 displays the transmitted video.

### Advantageous Effects

In the second embodiment, the remote imaging-and-controlling system 1a switches between the cameras of an imager 11a to be described later, making it possible to output more readily a video having a resolution or a frame rate based on a moving speed of the vehicle.

### Third Embodiment

Described below is another embodiment of the present invention. Note that, for the sake of description, constituent features having the same function between this embodiment and the above embodiments are denoted with the same reference sign. Such constituent features will not be repeatedly elaborated upon.

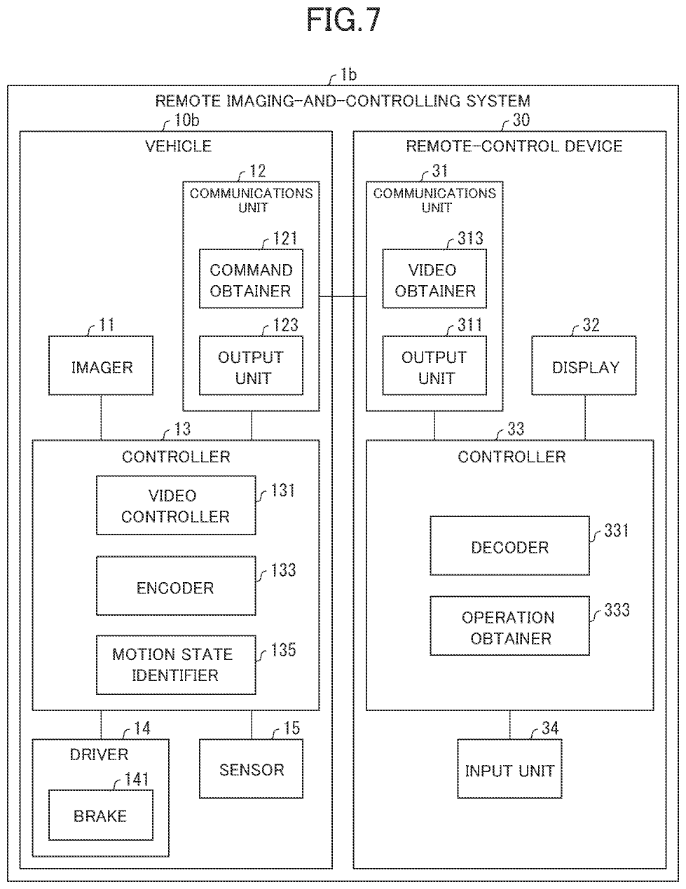

FIG. 7 is a functional block diagram of a remote imaging-and-controlling system according to the third embodiment of the present invention. As illustrated in FIG. 7, a remote imaging-and-controlling system 1b includes: a vehicle 10b; and the remote-control device 30. Other than a sensor 15, the vehicle 10b is the same in configuration as the vehicle 10 of the first embodiment. The remote-control device 30 is the same in configuration as that of the first embodiment.

Sensor 15

The sensor 15 obtains information indicating at least one of a speed, an acceleration, and a positional change of the vehicle 10b. The motion state identifier 135 can refer to the obtained information. The obtained information may be transmitted to the controller 13, and displayed on the display 32 of the remote-control device 30.

Process

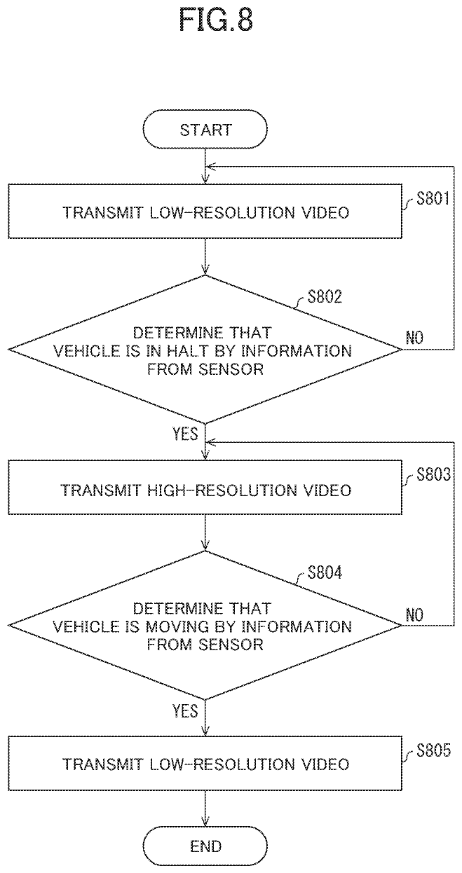

FIG. 8 is a flowchart according to the third embodiment of the present invention. The flowchart in FIG. 8 shows a process in which, (i) if the motion state identifier 135 determines that the vehicle 10b is moving, the vehicle 10b obtains a low-resolution video and transmits the obtained low-resolution video to the remote-control device 30, and (ii) if the motion state identifier 135 determines that the vehicle is in a halt, the vehicle 10b obtains a high-resolution video and transmits the obtained high-resolution video to the remote-control device 30. The flowchart in FIG. 8 starts when the vehicle 10b starts to move and capture a video.

Step S801

At Step S801, the vehicle 10b is moving. When the imager 11 captures a video, the video controller 131 replaces the captured video with a low-resolution video, and the vehicle 10b transmits the low-resolution video to the remote-control device 30. The display 32 displays the transmitted low-resolution video.

Step S802

At Step S802, if the motion state identifier 135 determines in accordance with information from the sensor 15 that the vehicle 10b is in a halt (Step S802: YES), the process proceeds to Step S803. If the motion state identifier 135 determines in accordance with the information from the sensor 15 that the vehicle 10b is moving (Step S802: YES), the process returns to Step S801. When the imager 11 captures a video, the video controller 131 replaces the captured video with a low-resolution video. The vehicle 10b transmits the low-resolution video to the remote-control device 30. The display 32 displays the transmitted low-resolution video.

Step S803

At Step S803, when the imager 11 obtains a video, the video controller 131 replaces the obtained video with a high-resolution video. The vehicle 10b transmits the high-resolution video to the remote-control device 30. The display 32 displays the transmitted high-resolution image, and the process proceeds to Step S804.

Step S804

At Step S804, if the motion state identifier 135 determines in accordance with information from the sensor 15 that the vehicle 10b has started moving (Step S804: YES), the process proceeds to Step S805. If the motion state identifier 135 determines that the vehicle 10b is in a halt (Step S804: NO), the process returns to Step S803. When the imager 11 captures a video, the video controller 131 replaces the captured video with a high-resolution video. The vehicle 10b transmits the high-resolution video to the remote-control device 30. The display 32 displays the transmitted high-resolution video.

Step S805

At Step S805, the vehicle 10b is moving. When the imager 11 captures a video, the video controller 131 replaces the captured video with a low-resolution video, and the vehicle 10b transmits the low-resolution video to the remote-control device 30. The display 32 displays the transmitted low-resolution video.

### Advantageous Effects

In the third embodiment, the remote imaging-and-controlling system 1b can appropriately determine whether the vehicle 10b is moving.

Modification 1

One aspect of the third embodiment may include the imager 11b having the cameras A111 and B113 according to the second embodiment.

This modification is a combination of the second and third embodiments. This modification involves the determination executed in the third embodiment in accordance with the process described in the second embodiment.

Specifically, this embodiment involves capturing a video with the cameras A111 and B113 in accordance with the process described in the second embodiment. In the determination to switch between the camera A111 and the camera B113, as described in the third embodiment, the motion state identifier 135 refers to information from the sensor 15; that is, information indicating at least one of a speed, an acceleration, and a positional change of the vehicle 10b.

In this modification, the remote imaging-and-controlling system 1b can determine more appropriately whether the vehicle 10b is moving.

Modification 2

In one aspect of the third embodiment, the vehicle 10b may be an aerial vehicle. The aerial vehicle includes a mechanism to vertically move the vehicle 10b.

In this modification, the remote imaging-and-controlling system 1b can capture videos of places inaccessible from the ground such as isolated islands and mountains.

### Additional Features According to First to Third Embodiments

The above embodiments describe configuration examples in which the video controller 131 controls at least one of: (i) a resolution of a video to be captured by the imager 11 (11a); (ii) a frame rate of the video to be captured by the imager 11 (11a); (iii) a resolution of the video to be encoded by the encoder 133; and (iv) a bit rate of the video encoded by the encoder 133, so that the video to be transmitted to the remote-control device 30 is switched between two video qualities. The control by the video controller 131 shall not be limited to such control. Alternatively, the video controller 131 may control such constituent features as the imager 11 in accordance with, for example, a speed of the vehicle (10a, 10b), so that the quality of the image to be transmitted to the remote-control device 30 changes seamlessly or stepwise.

Software Implementation

The control blocks of the vehicles 10, 10a, and 10b (in particular, the communications unit 12 and the controller 13) and the control blocks of the remote-control device 30 (in particular, the communications unit 31 and the controller 33) may be implemented by logic circuits (hardware) fabricated, for example, in the form of an integrated circuit (IC chip) and may be implemented by software.

In the latter form of the implementation, the vehicles 10, 10a, and 10b include a computer executing instructions from programs; namely, software by which various functions are implemented. This computer includes among others at least one processor (a controller) and at least one storage medium containing the programs in a computer-readable format. The processor in the computer then retrieves and runs the programs contained in the storage medium, thereby achieving the object of the present invention. The processor may be, for example, a central processing unit (CPU). The storage medium may be a “non-transitory, tangible medium” such as a read-only memory (ROM), a tape, a disc/disk, a card, a semiconductor memory, or programmable logic circuitry. The processor may further include, for example, a random access memory (RAM) for loading the programs. The programs may be supplied to the computer via any transmission medium (e.g., over a communications network or by broadcasting waves) that can transmit the programs. The present invention, in an aspect thereof, encompasses data signals on a carrier wave that are generated during electronic transmission of the programs.

### SUMMARY

A vehicle (10, 10a, 10b) according to a first aspect of the present invention includes: a command obtainer (121) obtaining information indicating a command of a user and determining a motion of the vehicle (10, 10a, 10b); a driver (14) moving the vehicle (10, 10a, 10b) in accordance with the information determining the motion; an imager (11, 11a) capturing a video around the vehicle (10, 10a, 10b); an encoder (133) encoding the video captured by the imager (11, 11a); a motion state identifier (135) identifying a motion state of the vehicle (10, 10a, 10b); a video controller (131) controlling, depending on the motion state, at least one of: (i) a resolution of the video to be captured by the imager (11, 11a); (ii) a frame rate of the video to be captured by the imager (11, 11a); (iii) a resolution of the video to be encoded by the encoder (133); and (iv) a bit rate of the video encoded by the encoder (133); and an output unit (123) outputting the video encoded by the encoder (133).

The above features make it possible to output a video having a resolution or a bit rate based on a moving speed of the vehicle (10, 10a, 10b).

In the vehicle (10, 10a, 10b) of a second aspect according to the first aspect, the video controller may set at least one of: (i) the resolution of the video to be captured by the imager (11, 11a); (ii) the frame rate of the video to be captured by the imager (11, 11a); (iii) the resolution of the video to be encoded by the encoder (133); and (iv) the bit rate of the video encoded by the encoder (133) higher when the motion state indicates that the vehicle (10, 10a, 10b) is in a halt than when the motion state indicates that the vehicle (10, 10a, 10b) is moving.

In the above feature, the remote imaging-and-controlling system (1, 1a, 1b) switches between the cameras of the imager (11a) to be described later, making it possible to output more readily a video having a resolution or a frame rate based on a moving speed of the vehicle (1, 10a, 10b).

In the vehicle (10, 10a, 10b) of a third aspect according to the first or second aspect, the motion state identifier (135) may identify the motion state of the vehicle (10, 10a, 10b) with reference to a control signal to be supplied to the driver (14).

In the above feature, the remote imaging-and-controlling system (1, 1a, 1b) can appropriately determine whether the vehicle (10, 10a, 10b) is moving.

In the vehicle (10, 10a, 10b) of a fourth aspect according to the first or second aspect, the motion state identifier (135) may obtain information indicating, as the motion state, at least one of whether the driver (14) is operating, and whether a brake (141) is being applied on the driver (14).

The above feature provides the same advantageous effects as the first aspect does.

In the vehicle (10, 10a, 10b) of a fifth aspect according to the first or second aspect, the motion state identifier (135) may obtain information indicating, as the motion state, at least one of a speed, an acceleration, and a positional change of the vehicle (10, 10a, 10b).

In the above feature, the remote imaging-and-controlling system (1, 1a, 1b) can determine more appropriately whether the vehicle (10, 10a, 10b) is moving.

In the vehicle (10, 10a, 10b) of a sixth aspect according to the fifth aspect, the vehicle (10, 10a, 10b) may be an aerial vehicle, and the driver (14) may include a mechanism vertically moving the vehicle (10, 10a, 10b).

In the above feature, the remote imaging-and-controlling system (1, 1a, 1b) can capture videos of places inaccessible from the ground such as isolated islands and mountains.

A remote imaging-and-controlling system (1, 1a, 1b) according to a seventh aspect of the present invention includes: a vehicle (10, 10a, 10b); and a controller (30). The vehicle (10, 10a, 10b) includes: a command obtainer (121) obtaining, from the controller (30), information indicating a command of a user and determining a motion of the vehicle (10, 10a, 10b); a driver (14) moving the vehicle (10, 10a, 10b) in accordance with the information determining the motion; an imager (11, 11a) capturing a video around the vehicle (10, 10a, 10b); an encoder (133) encoding the video captured by the imager (11, 11a); a motion state identifier (135) identifying a motion state of the vehicle (10, 10a, 10b); a video controller (131) controlling, depending on the motion state, at least one of: (i) a resolution of the video to be captured by the imager (11, 11a); (ii) a frame rate of the video to be captured by the imager (11, 11a); (iii) a resolution of the video to be encoded by the encoder (133); and (iv) a bit rate of the video encoded by the encoder (133); and a first output unit (123) outputting, to the controller, the video encoded by the encoder. The controller (30) includes: a video obtainer (313) obtaining the encoded video from the vehicle (10, 10a, 10b); a decoder (331) decoding the encoded video; a display (32) displaying the video decoded by the decoder (331); an operation obtainer (333) obtaining the information indicating the command of the user and determining the motion of the vehicle (10, 10a, 10b); and a second output unit (311) outputting, to the vehicle (10, 10a, 10b), the information obtained by the operation obtainer (333).

The remote imaging-and-controlling system (1, 1a, 1b) including the above features can output a video having a resolution or a bit rate based on a moving speed of the vehicle (10, 10a, 10b).

A method according to an eighth aspect of the present invention is directed to controlling a vehicle (10, 10a, 10b). The method includes: obtaining information indicating a command of a user and determining a motion of the vehicle (10, 10a, 10b); moving the vehicle (10, 10a, 10b) in accordance with the information determining the motion; capturing a video around the vehicle (10, 10a, 10b); encoding the video captured in the capturing; identifying a motion state of the vehicle (10, 10a, 10b); (i) a resolution of the video to be captured in the capturing; (ii) a frame rate of the video to be captured in the capturing; (iii) a resolution of the video to be encoded in the encoding; and (iv) a bit rate of the video encoded in the encoding; and outputting the video encoded in the encoding.

The above feature provides the same advantageous effects as the first aspect does.

The control blocks (in particular, the communications unit (12) and the controller (13)) of the vehicle (10, 10a, 10b) and the control blocks (in particular, the communications unit (31) and the controller (33)) of the remote-control device (30) according to the aspects of the present invention may be implemented by a computer. In this case, the scope of the present invention includes control programs and communications programs of the vehicle (10, 10a, 10b) and the remote-control device (30), to implement the vehicle (10,10a, 10b) and the remote-control device (30) on the computer by causing the computer to operate as constituent features (software programs) included in the vehicle (10, 10a, 10b) and the remote-control device (30). The scope of the present invention also includes a storage medium including such programs in a computer-readable format.

The present invention shall not be limited to the embodiments described above, and can be modified in various manners within the scope of claims. The technical aspects disclosed in different embodiments are to be appropriately combined together to implement another embodiment. Such an embodiment shall be included within the technical scope of the present invention. Moreover, the technical aspects disclosed in each embodiment are combined to achieve a new technical feature.

While there have been described what are at present considered to be certain embodiments of the invention, it will be understood that various modifications may be made thereto, and it is intended that the appended claims cover all such modifications as fall within the true spirit and scope of the invention.

1. A vehicle, comprising:
a command obtainer configured to obtain information indicating a command of a user and determining a motion of the vehicle;
a driver configured to move the vehicle in accordance with the information determining the motion;
an imager configured to capture a video around the vehicle;
an encoder configured to encode the video captured by the imager,
a motion state identifier configured to identify a motion state of the vehicle;
a video controller configured to control, depending on the motion state, at least one of:
(i) a resolution of the video to be captured by the imager;
(ii) a frame rate of the video to be captured by the imager;
(iii) a resolution of the video to be encoded by the encoder, and
(iv) a bit rate of the video encoded by the encoder; and
an output unit configured to output the video encoded by the encoder.

2. The vehicle according to claim 1, wherein
the video controller sets at least one of:
(i) the resolution of the video to be captured by the imager,
(ii) the frame rate of the video to be captured by the imager;
(iii) the resolution of the video to be encoded by the encoder; and
(iv) the bit rate of the video encoded by the encoder
higher when the motion state indicates that the vehicle is in a halt than when the motion state indicates that the vehicle is moving.

3. The vehicle according to claim 1, wherein
the motion state identifier identifies the motion state of the vehicle with reference to a control signal to be supplied to the driver.

4. The vehicle according to claim 1, wherein
the motion state identifier obtains information indicating, as the motion state, at least one of whether the driver is operating, and whether a brake is being applied on the driver.

5. The vehicle according to claim 1, wherein
the motion state identifier obtains information indicating, as the motion state, at least one of a speed, an acceleration, and a positional change of the vehicle.

6. The vehicle according to claim 5, wherein
the vehicle is an aerial vehicle, and
the driver includes a mechanism configured to vertically move the vehicle.

7. A remote imaging-and-controlling system, comprising:
a vehicle; and
a controller,
the vehicle including:
a command obtainer configured to obtain, from the controller, information indicating a command of a user and determining a motion of the vehicle;
a driver configured to move the vehicle in accordance with the information determining the motion;
an imager configured to capture a video around the vehicle;
an encoder configured to encode the video captured by the imager;
a motion state identifier configured to identify a motion state of the vehicle;
a video controller configured to control, depending on the motion state, at least one of:
(i) a resolution of the video to be captured by the imager;
(ii) a frame rate of the video to be captured by the imager;
(iii) a resolution of the video to be encoded by the encoder, and
(iv) a bit rate of the video encoded by the encoder, and
a first output unit configured to output, to the controller, the video encoded by the encoder, and
the controller including:
a video obtainer configured to obtain the encoded video from the vehicle;
a decoder configured to decode the encoded video;
a display configured to display the video decoded by the decoder;
an operation obtainer configured to obtain the information indicating the command of the user and determining the motion of the vehicle; and
a second output unit configured to output, to the vehicle, the information obtained by the operation obtainer.

8. A method for controlling a vehicle, the method comprising:
obtaining information indicating a command of a user and determining a motion of the vehicle;
moving the vehicle in accordance with the information determining the motion;
capturing a video around the vehicle;
encoding the video captured in the capturing;
identifying a motion state of the vehicle;
controlling, depending on the motion state, at least one of:
(i) a resolution of the video to be captured in the capturing;
(ii) a frame rate of the video to be captured in the capturing;
(iii) a resolution of the video to be encoded in the encoding; and
(iv) a bit rate of the video encoded in the encoding; and
outputting the video encoded in the encoding.

9. A computer-readable non-transitory storage medium containing a control program for causing the vehicle according to claim 1 to operate as the command obtainer, the encoder, the motion state identifier, the video controller, and the output unit.
